(19) United States
(12) Patent Application Publication
(10) Pub. No.: US 2006/0237057 A1
(43) Pub. Date: Oct. 26, 2006

(54) Solar power system

(75) Inventors: Arnold Willem Buij, Eindhoven (NL); Johannes Martinus Maria Welschen, Eindhoven (NL); Hein Herman Willem Nab, Eindhoven (NL); Rony Andreas Antonius Maria Jacobs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKIJKLE PHILLIPS ELECTRONICS N.V.

(21) Appl. No.: 10/552,762

(22) PCT Filed: Apr. 8, 2004
(86) PCT No.: PCT/IB04/50411

§ 371 Date: Oct. 12, 2005

(30) Foreign Application Priority Data
Apr. 15, 2003 (EP) 03101024.2

(51) Int. Cl. H02N 6/00

(52) U.S. Cl. 136/244

(57) ABSTRACT

In a solar power systetm a ground fault detection system with switched reference levels is used. As a consequence the leakage resistance of the euipment can always be determined.

The invention relates to a solar power system equipped with
a solar panel comprising
   a first output terminal and a second output terminal,
   a series arrangement of photovoltaic cells arranged between the output terminals,
ground fault detection means comprising
   a detection circuit equipped with a series arrangement SA comprising a first and a second ohmic resistor and connecting the first and second output terminals,
   a first signal generator for generating a signal S1 that represents the voltage difference ΔV between a common terminal of the first and the second ohmic resistor and the second output terminal,
a safety circuit coupled to the ground fault detection means for changing the operating state of the solar power system in dependency of the signal S1.

The invention also relates to a housing comprising the ground fault detection means and the safety circuit.

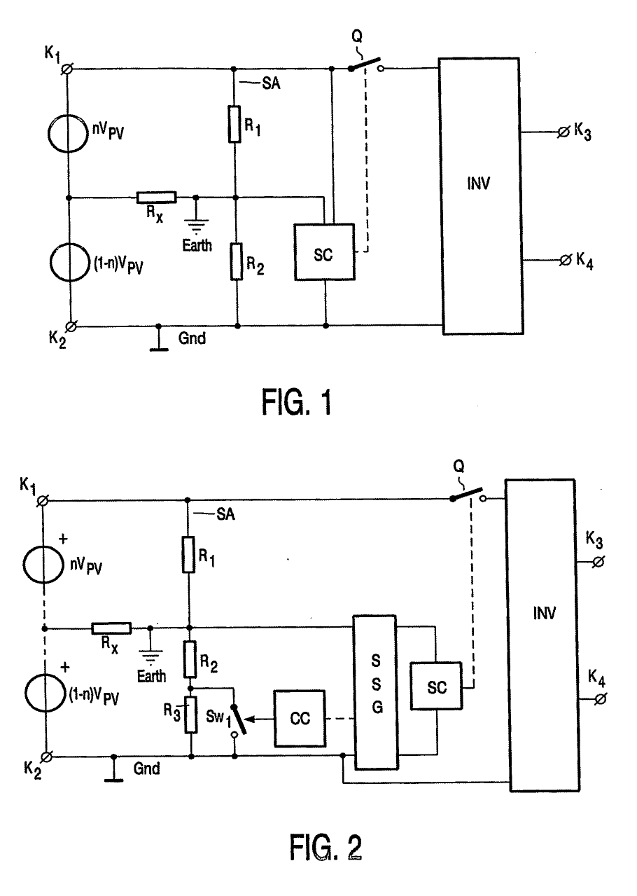

A solar power system as mentioned in the opening paragraph is generally known. It is noted that the solar panel may comprise a string of series arranged sub-panels. The solar panel and the ground fault detection means used in such a solar power system is shown in FIG. 1. Vpv represents the total voltage of a series arrangement of photovoltaic cells connected between first output terminal K1 and second output terminal K2. (1−n)Vpv represents the voltage generated by a first fraction of the photovoltaic cells and nVpv represents the voltage generated by a second fraction of the photovoltaic cells. n has a value between zero and one. Rx represents a leakage resistor that connects a point of the solar panel between the first and second fraction of photovoltaic cells to earth potential. Earth potential means the potential of the environment that the solar power system is placed in. In the known solar power system the common terminal of the first ohmic resistor R1 and the second ohmic resistor R2 is coupled to earth potential. Circuit part SC is a safety circuit for changing the operating state of the solar power converter in dependency of the signal S1. A first signal generator for generating signal S1 is formed by the ohmic resistor R2. In the circuitry shown in FIG. 1, the signal S1 is equal to the voltage difference ΔV. A first input terminal of safety circuit SC is connected to the common terminal of ohmic resistor R1 and ohmic resistor R2. A second input terminal of safety circuit SC is connected to the second output terminal K2 of the solar panel. A third input terminal is connected to the first output terminal K1 of the solar panel. The first output terminal K1 of the solar panel is connected to a first input terminal of a DC-AC-converter INV by means of a switching element Q. During operation, the DC-AC-converter converts a DC-current supplied by the solar panel into an AC-current that is supplied to the mains. An output terminal of the safety circuit SC is connected to a control electrode of the switching element Q. In FIG. 1 this connection is indicated by means of a dotted line. A second input terminal of the DC-AC-converter INV is connected to the second output terminal K2. K3 and K4 are first and second output terminals of the DC-AC-converter INV for connection to the mains.

The operation of the solar power system shown in FIG. 1 is as follows. In practise it is often assumed that n=1 or 0, in other words it is assumed that leakage of current to earth is taking place at the first output terminal K1 or the second output terminal K2 or the wiring connected to these output terminals. When it is assumed for instance that n=1, the leakage resistor Rx is in parallel with ohmic resistor R1. When the resistances of ohmic resistors R1 and R2 are for instance chosen equal, the voltage difference ΔV would be 0.5*Vpv, in case the resistance of the leakage resistor Rx is infinitely high. In case the resistance of the leakage resistor has a finite value, the value of the voltage difference ΔV will be higher than 0.5*Vpv and the resistance of leakage resistor Rx can easily be derived from the value of the voltage difference ΔV. Because of the unambiguous relation between the voltage difference ΔV and the leakage resistance when n=1, the voltage difference ΔV is a signal that represents the leakage resistance. In case the value of the voltage difference ΔV becomes higher than a predetermined reference value, the safety circuit SC renders the switch Q non-conductive so that the inverter cannot supply any power to the mains. Generally the DC-AC-converter is equipped with one or more switching elements and a control circuit for controlling the conductive state of the switching elements. Instead of making use of the switching element Q, it is also possible disable the control circuit comprised in the DC-AC-converter for controlling the switching elements comprised in the DC-AC-converter.

Similarly, when it is assumed that n=0, the leakage resistor is in parallel with ohmic resistor R2. In case the resistances of ohmic resistors R1 and R2 are again chosen equal, a finite value of the resistance of the leakage resistor Rx corresponds to a value of the voltage difference ΔV that is smaller than 0.5*Vpv and the resistance of the leakage resistor Rx is again unambiguously represented by the voltage difference ΔV. In this case (n=0) the safety circuit SC renders the switching element Q non-conductive when the voltage difference ΔV becomes smaller than a predetermined reference value.

In practise, however, the leakage is not always taking place from one of the output terminals K1 and K2 but can also take place from a terminal situated in the solar panel between the output terminals. In other words the value of n is somewhere between 0 and 1 but is generally not exactly known. It can be seen (FIG. 1) that in such a case, a situation can occur in which the leakage resistor Rx has a finite value but does not carry a leakage current because R1/R2=n/(1−n). In this case the value of the voltage difference ΔV will not be influenced by a leakage current through Rx, so that the leakage remains undetected. For every other relation between n, R1 and R2 (in other words for R1/R2≠n/(1−n)) the current through the leakage resistor Rx will not be zero, so that a leakage current through Rx will cause the value of the voltage difference ΔV to differ from R1*Vpv/(R1+R2) and the leakage is detected. However, since the value of n is unknown, the relation between the resistance of Rx and the value of the voltage difference ΔV is also not known. In practise this poses a severe problem since regulations exist that require that the solar power system is not switched on or is switched off, in case the resistance of Rx drops below a predetermined value.

It is an object of the invention to provide a solar power system comprising a ground fault detection system that allows an accurate determination of the resistance of Rx under all circumstances.

A solar power system as mentioned in the opening paragraph is therefor in accordance with the invention characterized in that the ground fault detection means is further equipped with
a third ohmic resistor comprised in the series arrangement SA,
a switching circuit part comprising a switching element and shunting the third ohmic resistor,
a control circuit coupled to a control electrode of the switching element for controlling the conductive state of the switching element, and
a second signal generator coupled between the first signal generator and the safety circuit for generating a second signal S2 representing leakage resistance between the solar power system and its environment.

In a circuit arrangement according to the invention the voltage difference ΔV is measured both when the control circuit has rendered the switching element comprised in the switching circuit non-conducting and when the control circuit has rendered the switching element comprised in the switching circuit conducting. From these two measurements both n and the resistance of Rx can be derived by the second signal generator under all circumstances, so that the safety circuit can for instance disconnect the load from the solar power system in case the amount of leakage makes such an action necessary.

In a preferred embodiment of the solar power system according to the invention, the solar power system further comprises a DC-AC-converter coupled to the first and second output terminal of the solar panel. Such a DC-AC-converter can for instance be used to convert the DC-current that is generated by the solar panel into an AC-current that is supplied to the mains.

Preferably the third ohmic resistor comprised in the series arrangement SA is coupled between the second output terminal and the second ohmic resistor. An important advantage is that the control circuit controlling the switching element comprised in the switching circuit does not need to comprise a level shifter and can therefor be comparatively simple.

It has been found that it is advantageous in case the second signal generator comprises a microcontroller to derive the value of the leak resistance Rx from the two measurements of ΔV that are done with the switching element comprised in the switching circuit conducting and non-conducting.

To protect the circuitry comprised in the ground fault detection means and the safety circuit against moisture etc., both these circuit parts can be contained in a housing. In case the solar power converter comprises a DC-AC-converter, the DC-AC-converter is preferably contained in the housing too.

An embodiment of a solar power system according to the invention will be explained making reference to a drawing. In the drawing,

FIG. 1 shows a prior art solar power system, and

FIG. 2 shows a solar power system according to the invention.

The solar power system shown in FIG. 1 has been discussed hereabove.

In FIG. 2 components and circuit parts that are similar to components and circuit parts in FIG. 1 have been labeled with the same references. Also in FIG. 2, Vpv represents the total voltage of a series arrangement of photovoltaic cells connected between first output terminal K1 and second output terminal K2. (1−n)Vpv represents the voltage generated by a first fraction of the photovoltaic cells and nVpv represents the voltage generated by a second fraction of the photovoltaic cells. n has a value between zero and one. Rx represents a leakage resistor that connects a point of the solar panel between the first and second fraction of photovoltaic cells to earth potential. In the solar power system shown in FIG. 2, the first output terminal K1 is connected to the second output terminal K2 by means of a series arrangement of three ohmic resistors R1, R2 and R3, forming a series arrangement SA. A common terminal of ohmic resistor R1 and ohmic resistor R2 is connected to earth. Ohmic resistor R3 is shunted by means of a switching element SW1 that forms a switching circuit part. Circuit part CC is a control circuit for controlling the conductive state of the switching element SW1. A control electrode of the switching element SW1 is coupled to an output terminal of circuit part CC. The series arrangement of ohmic resistor R2 and R3 together with the switching element SW1 and the control circuit CC form a first signal generator for generating a signal S1 that represents the voltage difference ΔV between a common terminal of the first ohmic resistor R1 and the second ohmic resistor R2 and the second output terminal K2. In fact in this embodiment the signal S1 is equal to the voltage difference ΔV. Circuit part SSG is a second signal generator for generating a second signal S2 representing the value of the leakage resistance Rx between the solar power system and its environment. Circuit part SSG comprises a microcontroller not shown in FIG. 2. Respective input terminals of circuit part SSG are connected to the common terminal of ohmic resistor R1 and ohmic resistor R2 and the second output terminal K2 respectively. A further input terminal of circuit part SSG is connected to the first output terminal K1 of the solar panel. Respective input terminals of safety circuit SC are connected to respective output terminals of circuit part SSG. Via a further output terminal of the circuit part SSG, an output terminal of the microcontroller comprised in circuit part SSG is connected to an input terminal of the control circuit CC. Via this connection the microcontroller can activate the control circuit CC to render the switching element SW1 conducting or non-conducting. In FIG. 2 this connection is indicated by means of a dotted line. The first output terminal K1 of the solar panel is connected to a first input terminal of a DC-AC-converter INV by means of a switching element Q. An output terminal of the safety circuit SC is connected with a control electrode of the switching element Q. This connection is indicated by means of a dotted line. A second input terminal of the DC-AC-converter INV is connected to the second output terminal K2. K3 and K4 are first and second output terminals of the DC-AC-converter INV for connection to the mains.

The operation of the solar power system shown in FIG. 2 is as follows.

Immediately after the solar power system has become operative the micro controller ensures that the control circuit CC maintains the ground fault detection means in a first operating state. In this first operating state of the ground fault detection means, the switching element SW1 is maintained in a non-conductive state. The value ΔV1 of the voltage ΔV in this first operating state is measured and stored in a memory comprised in circuit part SSG. Subsequently, the microcontroller ensures that the ground fault detection means are maintained in a second operating state. In this second operating state of the ground fault detection means, the switching element SW1 is rendered conductive. Since the ohmic resistor R3 is thereby effectively switched out of the series arrangement SA, the voltage difference ΔV has a second value ΔV2 differing from the first value that is also stored in the memory comprised in circuit part SSG.

The following equation applies
ΔV=Vpv*(RxRy+RyR1(1−n))/(RxRy+RyR1+RxR1)
In the first operating state ΔV=ΔV1 and Ry=R2+R3, while in the second operating state ΔV=ΔV2 and Ry=R2. Substitution into the equation provides two equations with two unknown parameters (n and Rx). The value of both parameters can be found by the microcontroller from these equations. When the value of Rx is smaller than a predetermined reference value, the safety circuit SC renders the switching element Q non-conducting so that the DC-AC-converter is maintained inoperative. It is noted that the value of Vpv strongly depends on parameters such as the amount of sun light striking the solar panel, so that it is always necessary to measure the actual value of Vpv.
It will be mentioned that depending on the precise implementation of the ground fault detection means, the measurements of ΔV in the two different operating states of the ground fault detection means can be performed when the solar power system is first activated or switched on. The switching element Q is then maintained non-conductive so that the DC-AC-converter does not become operative, in case the leakage resistance Rx turns out to be smaller than the reference value. Alternatively the measurements can be performed regularly, e.g. every hour, or when the user of the solar power system commands the measurements to be performed, manually or for instance by means of a remote control device.

1. Solar power system equipped with
a solar panel comprising
a first output terminal and a second output terminal,
a series arrangement of photovoltaic cells arranged between the output terminals,
ground fault detection means comprising
a detection circuit equipped with a series arrangement SA comprising
a first and a second ohmic resistor and connecting the first and second output terminals,
a first signal generator for generating a signal S1 that represents the voltage difference ΔV between a common terminal of the first and the second ohmic resistor and the second output terminal,
a safety circuit coupled to the ground fault detection means for changing the operating state of the solar power system in dependency of the signal S1,
characterized in that the ground fault detection means is further equipped with
a third ohmic resistor comprised in the series arrangement SA,
a switching circuit part comprising a switching element and shunting the third ohmic resistor,
a control circuit coupled to a control electrode of the switching element for controlling the conductive state of the switching element, and
a second signal generator coupled between the first signal generator and the safety circuit for generating a second signal S2 representing leakage resistance between the solar power system and its environment.

2. Solar power system according to claim 1, wherein the solar power system further comprises a DC-AC-converter coupled to the first and second output terminal.

3. Solar power system according to claim 1, wherein the third ohmic resistor is coupled between the second output terminal and the second ohmic resistor.

4. Solar power system according to claim 1, wherein the second signal generator comprises a microcontroller.

5. Solar power system according to claim 1, wherein the solar power system comprises a housing containing the ground fault detection means and the safety circuit.

6. Solar power system according to claim 2, wherein the housing further contains the DC-AC-converter.
